(19) United States
(12) Patent Application Publication
(10) Pub. No.: US 2020/0304313 A1
(43) Pub. Date: Sep. 24, 2020

(54) ELECTRONIC SIGNATURE AND ACKNOWLEDGEMENT APPROACHES

(71) Applicant: ServiceNow, Inc., Santa Clara, CA (US)

(72) Inventors: Debajit Choudhury, Hyderabad (IN); Venkata Naveen Karlapudi, Hyderabad (IN); Nikhil Kumar Gupta, Hyderabad (IN); Leena Gian Dudani, Sunnyvale, CA (US); Allan Daniel Woo Kwan, San Diego, CA (US)

(21) Appl. No.: 16/357,619

(22) Filed: Mar. 19, 2019

(51) Int. Cl. H04L 9/32; G06F 21/40; G06F 3/0482; G06F 3/0484

(52) U.S. Cl. CPC H04L 9/3247; G06F 3/04847; G06F 3/0482; G06F 21/40

(57) ABSTRACT

The present approach relates to techniques for facilitating acquisition of electronic signatures (e-signatures) and/or acknowledgements in the context of electronic forms or documents. In one aspect, a designer may be used to configure tasks corresponding to signature or acknowledgment events that may be added to a person's to-do list or task management application or portal. Interaction with the task to complete the task may then be in accordance with the guidance programmed by the designer, such as to acquire a signature or acknowledgment. In certain aspects, the signature or acknowledgement tasks may be configured for display and completion on a mobile device (e.g., a handheld device such as a phone or tablet computer).

### BACKGROUND

The present disclosure relates generally to electronic signature (e-signature) and acknowledgment implementations, including in a mobile environment.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, load balancers, firewalls, switches, etc.) and software resources (e.g. productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations, which resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able redirect their resources to focus on their enterprise's core functions.

One aspect of operating in such a computerized environment, whether on a cloud platform or otherwise, is that conventional, paper-based signature and/or acknowledgment approaches may difficult or impossible to implement in view of the reliance on electronic forms or documents. This may be further exacerbated in view of the continued adoption of mobile or handheld devices to view documents or forms.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present approach relates to techniques for facilitating acquisition of electronic signatures (e-signatures) and/or acknowledgements in the context of electronic forms or documents. In one aspect, a designer may be used to configure tasks corresponding to signature or acknowledgment tasks that may be added to a person's to-do list or task management application or portal. Interaction with the task (e.g., selecting the signature or acknowledgement task from a list of tasks) to complete may result in a set of options being provided to the user via an interface to allow the task to be completed in accordance with the guidance programmed by the designer, such as to acquire a signature or acknowledgment. Completion of the signature or acknowledgement task via the interface access through the task list may also allow the task to be automatically marked as completed on the list and removed from pending tasks. In certain aspects, the signature or acknowledgement tasks may be configured for display and completion on a mobile device (e.g., a handheld device such as a phone or tablet computer). Further, signature and/or acknowledgement functionality may be provided as part of an application plug-in or module, such that the electronic signature and/or acknowledgement functionality may be used in different application contexts (such as human resources, customer service, event or incident management, legal department, and/or accounting or finance contexts) without having to separately program this functionality into each context separately.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a virtual server supports and enables the client instance, in accordance with aspects of the present disclosure;

FIG. 5 depicts an interface of a designer for configuring a signature or acknowledgement task, in accordance with aspects of the present disclosure;

FIG. 6 depicts the interface of FIG. 5 showing further aspects related to selection of documents and configuration of acknowledgements, in accordance with aspects of the present disclosure;

FIG. 7 depicts an implementation of a task list and a submission task on a desktop computer and display, in accordance with aspects of the present disclosure;

FIG. 8 depicts an implementation of an electronic signature task on a desktop computer and display, in accordance with aspects of the present disclosure;

FIG. 9 depicts another implementation of an electronic signature task on a desktop computer and display, in accordance with aspects of the present disclosure;

FIG. 10 depicts a further implementation of an electronic signature task, in the form of a credential task, on a desktop computer and display, in accordance with aspects of the present disclosure;

FIG. 11 depicts an implementation of an electronic acknowledgement task on a desktop computer and display, in accordance with aspects of the present disclosure;

FIG. 12 depicts an implementation of a combined electronic signature and acknowledgment task on a desktop computer and display, in accordance with aspects of the present disclosure;

FIG. 13 depicts an implementation of an task list on a mobile device, in accordance with aspects of the present disclosure;

FIG. 14 depicts an implementation of a submission task on a mobile device, in accordance with aspects of the present disclosure;

FIG. 15 depicts an implementation of an electronic signature task initiation interface on a mobile device, in accordance with aspects of the present disclosure;

FIG. 16 depicts an implementation of an electronic signature task on a mobile device, in accordance with aspects of the present disclosure;

FIG. 17 depicts another implementation of an electronic signature task on a mobile device, in accordance with aspects of the present disclosure;

FIG. 18 depicts a further implementation of an electronic signature task, in the form of a credential task, on a mobile device, in accordance with aspects of the present disclosure;

FIG. 19 depicts an implementation of an electronic acknowledgement task initiation interface on a mobile device, in accordance with aspects of the present disclosure;

FIG. 20 depicts an implementation of an electronic acknowledgement task on a mobile device, in accordance with aspects of the present disclosure;

FIG. 21 depicts an implementation of a combined electronic signature and acknowledgment task initiation interface on a mobile device, in accordance with aspects of the present disclosure;

FIG. 22 depicts an implementation of a combined electronic signature and acknowledgment task on a mobile device, in accordance with aspects of the present disclosure;

FIG. 23 depicts further aspects of the implementation of the combined electronic signature and acknowledgment task of FIG. 22, in accordance with aspects of the present disclosure; and

FIG. 24 depicts locale aspects of an implementation of a combined electronic signature and acknowledgment task on a mobile device, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code. As used here-in a “plug-in” is a software component that adds a specific feature or functionality to other applications or routines when associated. In this manner, a respective plug-in may be associated with different applications or routines to add a common functionality in a modular fashion to the different applications or routines.

As used herein, a “signature” encompasses a task or the object of a task involving capturing the name of an individual (either representing themselves, another, or an entity or organization) in typed or written (e.g., drawn) form. A “credential”, in accordance with the discussion herein, may be considered a type or subset of signature corresponding to non-name identifying information (e.g., a password, security code, and so forth) provided by an individual for verification or other purposes. As used herein, an “acknowledgement” encompasses an indication that a term, condition, informational passage, or other statement has been read and acknowledged by an individual.

With the preceding in mind, the present approach relates to techniques for facilitating acquisition of electronic signatures (e-signatures) and/or acknowledgements in the context of electronic forms or documents. In one aspect, an application (e.g., an interface design application) may be used to configure signature or acknowledgment tasks that may be added to a person's to-do list or task management application or portal. Interaction with the task on the task list, such as to complete the task, may then be in accordance with the guidance programmed by the interface design application, such as to acquire a signature or acknowledgment before closing the task or proceeding to a next task. In certain aspects, the signature or acknowledgement tasks may be configured for display and completion on a mobile device (e.g., a handheld device such as a phone or tablet computer).

Further, the signature and/or acknowledgment functionality described herein, including design aspects and task list integration, may be provided as a plug-in, so as to allow incorporation (e.g., as a module, extension, or plug-in) into various different applications or routines, such as human resources applications, legal department applications, accounting and/or finance applications, customer service applications, event or incident management applications, and so forth. In this manner, a plug-in may be associated with different applications or routines to add a common functionality (e.g., electronic signature and/or acknowledgement functionality) in a modular fashion to the different applications or routines.

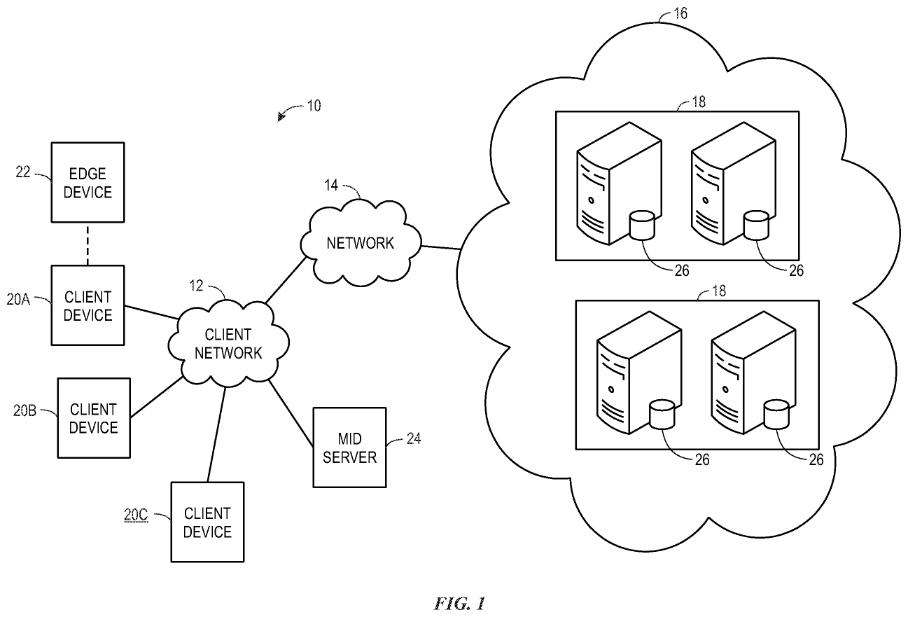

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, agent, or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

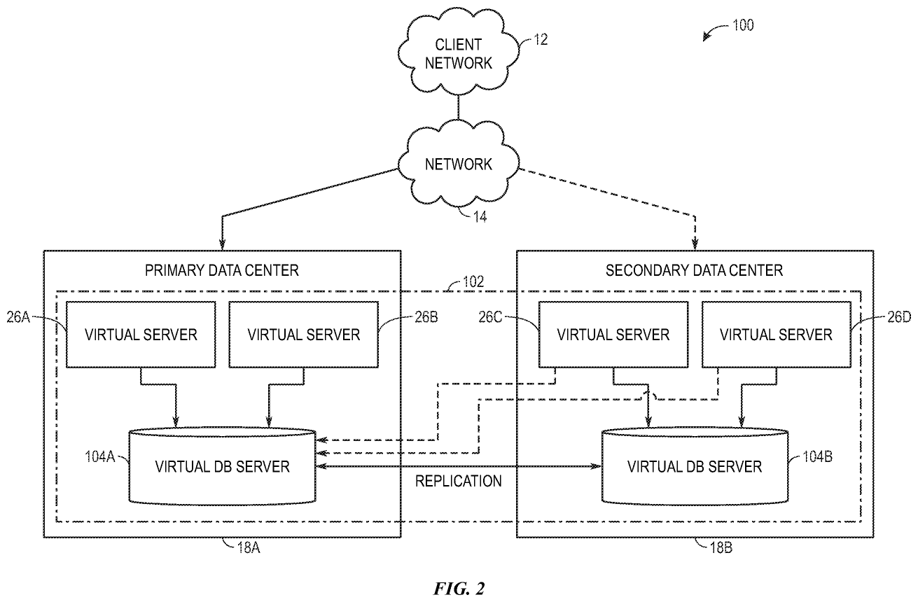

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

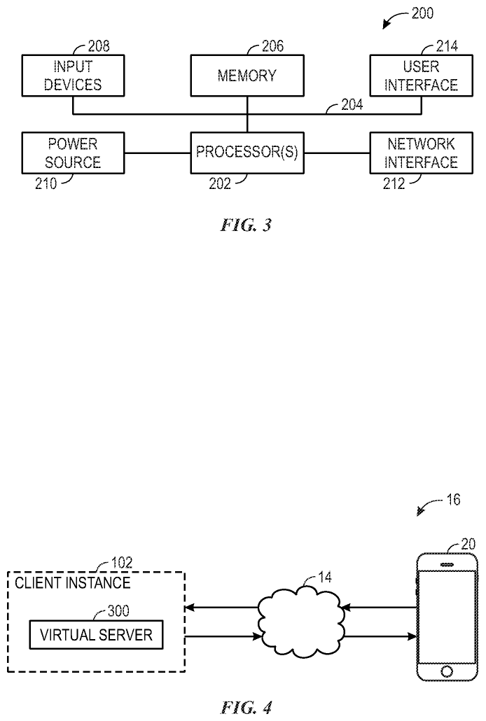

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

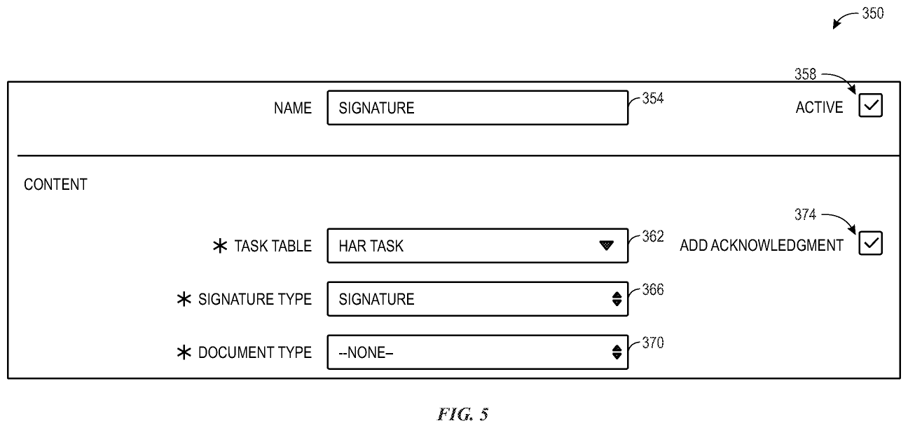

With the preceding in mind, FIG. 4 is a block diagram illustrating an embodiment in which a virtual server 300 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 (here depicted as a mobile or handheld device (e.g., cellular telephone or tablet computer)) via the network 14 to provide a user interface to network applications executing within the client instance 102 (e.g., via a web browser or application running on the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

As discussed herein, the present approach relates to techniques for facilitating acquisition of electronic signatures (e-signatures) and/or acknowledgements in the context of electronic forms or documents. In one aspect, an application (e.g., an interface design application) may be used to configure signature or acknowledgment tasks that may be added to a person's to-do list or task management application or portal. Interaction with the task on the task list, such as to complete the task, may then be in accordance with the guidance programmed by the interface design application, such as to acquire a signature or acknowledgment before closing the task or proceeding to a next task. In certain aspects, the signature or acknowledgement tasks may be configured for display and completion on a mobile device (e.g., a handheld device such as a phone or tablet computer).

Further, the signature and/or acknowledgment functionality described herein, including design aspects and task list integration, may be provided as a plug-in, so as to allow incorporation (e.g., as a module, extension, or plug-in) into various different applications or routines, such as human resources applications, legal department applications, accounting and/or finance applications, customer service applications, event or incident management applications, and so forth. In this manner, a plug-in may be associated with different applications or routines to add a common functionality (e.g., electronic signature and/or acknowledgement functionality) in a modular fashion to the different applications or routines.

Turning to the figures, FIG. 5 depicts a user interface 350 of an application (e.g., an interface design application) that may be used to create and/or configure a signature or acknowledgement task. Such a user interface 350 may be used to identify or otherwise specify content for which signature and/or acknowledgement tasks may be generated. In the depicted example, the user interface 350 provides a name field 354 in which a user may input a name for the task being created or modified (e.g., Form 21-B Signature, Termination Paperwork Acknowledgement, Disciplinary Acknowledgement and Signature, and so forth). A selectable option (e.g., checkbox 358) may be provided to toggle the task being created or modified between an active and inactive state.

In the depicted user interface 350, the task being created or modified may be associated with user selectable or specified content. For example, a task table field 362 may be used to specify (such as via free text entry or a pull down list) a task table referenced or linked to the task in question (e.g., a human resources task table, an accounting task table, a legal task table, and so forth). Likewise, a signature type field 366 may be provided to allow a user to specify (such as via free text entry or a pull down list) the type of signature (e.g., a typed signature, a drawn signature, a credential, and so forth) to be collected by the task that is being created or modified. The task may also be associated with a certain type of document or form via a document type field 370.

As discussed herein, the tasks created may additionally or alternatively request or require an acknowledgement by an individual, which is distinct from a signature or credential. With that in mind, the user interface 350 may also provide a selectable option (e.g., checkbox 374) that may be selected (e.g., checked) to toggle the addition of an acknowledgment between an active and inactive state for the task being created or modified. As discussed in example below, the example of a user interface 350 being described may be used to create or modify tasks that require only a signature, only an acknowledgment, or both a signature and acknowledgment.

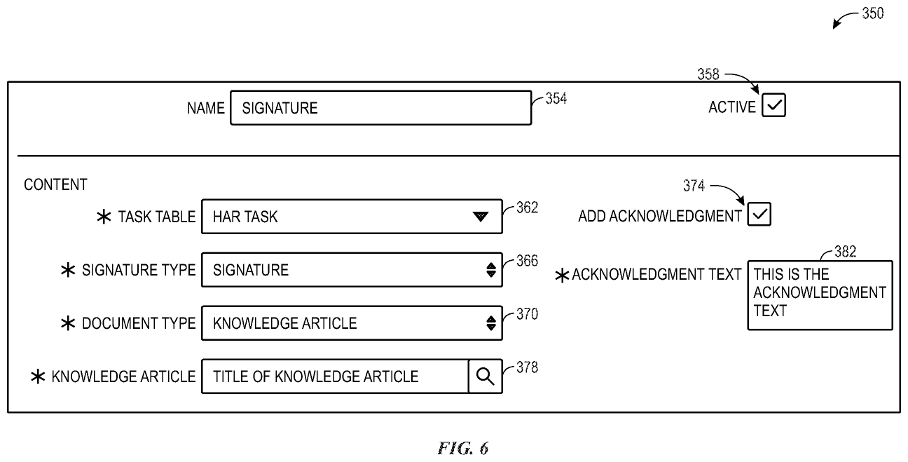

Turning to FIG. 6, the example of a user interface 350 is shown with additional fields that may be displayed in response to the content of certain of the fields shown in FIG. 5. In particular, in response to the content selected or otherwise entered for the document type field 370, a document selection field 378 may be displayed that allows the user to further specify a specific document with which to associate the task. In this example, the user has selected a document type of “Knowledge Article” in document type field 370, which spawns the display of a document selection field 378 specific to that document type (here a knowledge article selection field) that the user may use to select (such as via a drop down list or menu) the specific document of that type to associate with the task being created or modified.

In addition, the example of a user interface 350 shown in FIG. 6 also illustrates that upon a selection to add an acknowledgment, such as via a checkbox 374, an acknowledgement text entry field 382 may be displayed in which the user may enter or paste the text which an individual is to affirmatively acknowledge when completing the task in question. Examples, of such text may include, but is not limited to, liability or confidentiality waivers, agreements to release information or documents, agreements to retain information or documents in confidence, acknowledgments that documents or information has been received, and so forth.

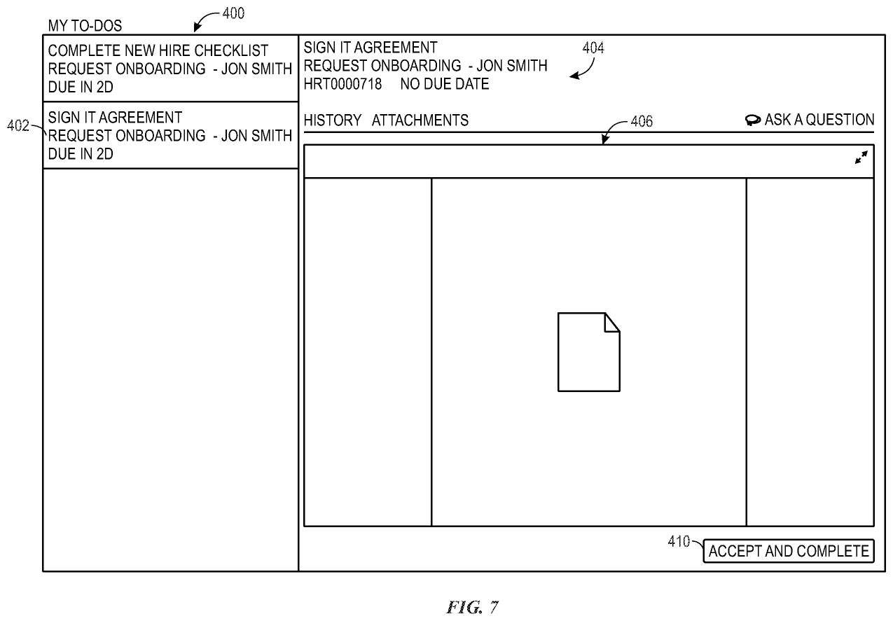

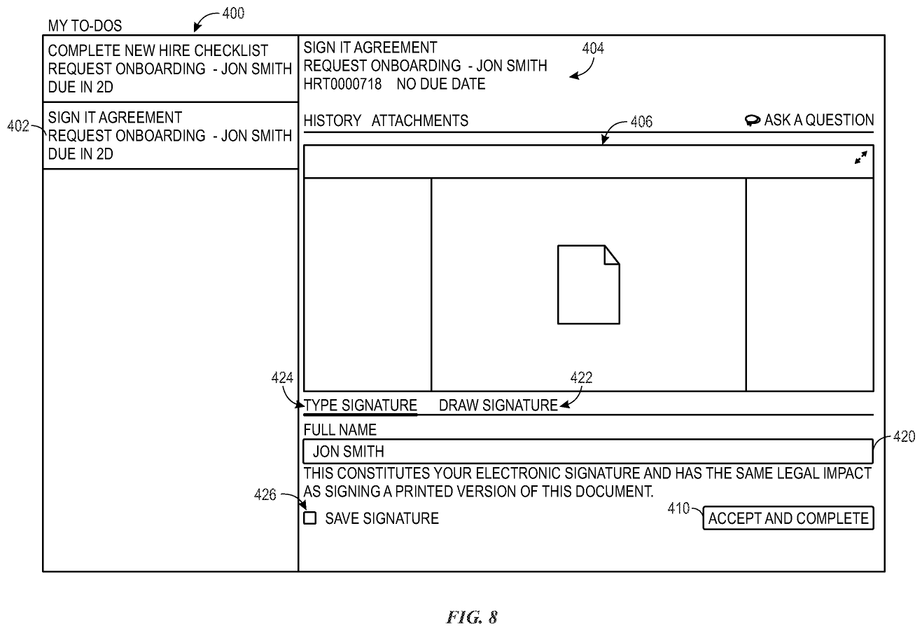

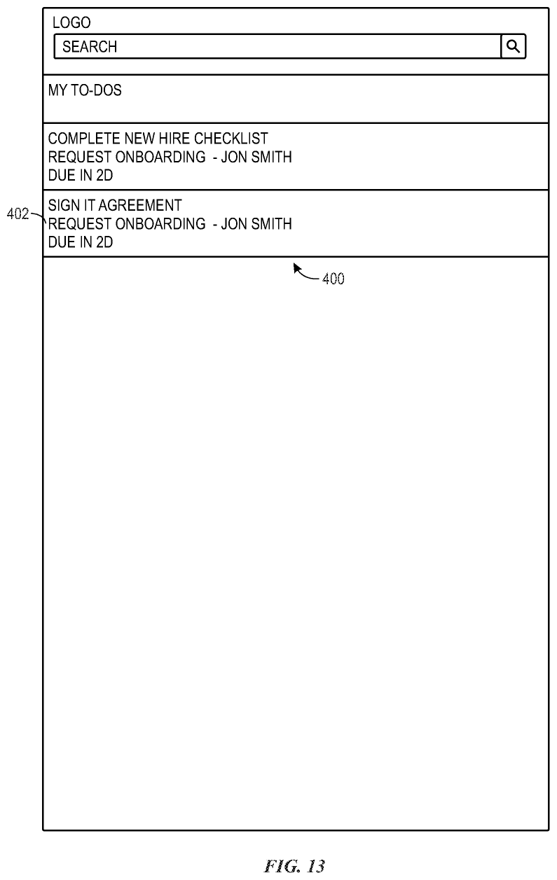

With the preceding in mind, FIGS. 7-25 depicts examples of implementations of signature and/or acknowledgement task implementations on both desktop and mobile devices, in accordance with the present approach. In these examples, FIGS. 7-12 correspond to desktop display examples while FIGS. 13-25 correspond to implementations on a mobile device.

Turning to the desktop display examples, FIG. 7, as a starting point, an example of a “to-do list” (i.e., a task list 400) that may be displayed on a user interface of an individual associated with an organization (e.g., a company, government, facility, and so forth). By way of example, the task list 400 may be displayed as part of a user portal or interface accessed as part of a client instance in a cloud computing environment. In the depicted example, the task list 400 includes a task 402 corresponding to accepting an agreement. As part of performing this task, information 404 about the task and an electronic form or document 406 corresponding to the agreement are displayed in a main pane of the interface when the task 402 is selected. In this baseline example, no specific signature or acknowledgement task has been defined for the task 402, so instead of a signature or acknowledgement, the task 402 may be completed simply by accepting (e.g., pressing “accept and complete” button 410) the electronic document 406 without providing an affirmative acknowledgement, signature, or credential.

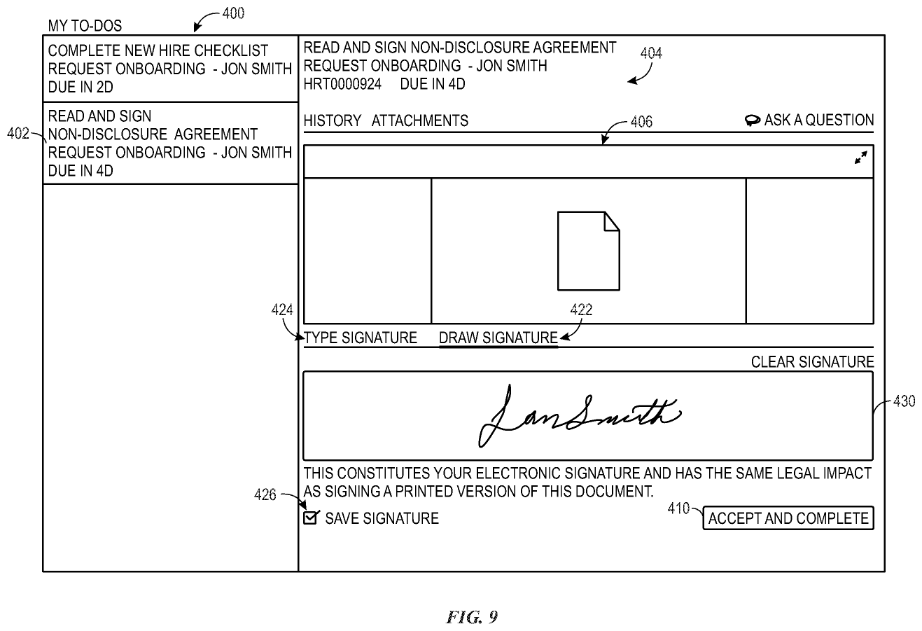

Turning to FIG. 8, in this example, the task 402 has been configured so as to require a signature. In the depicted example, requiring the signature to complete the task 402 prompts the display of a text entry box 420 as well as selectable tabs corresponding to a typed signature 424 or a drawn signature 422. In addition, a save signature box 426 is provided which, if selected, allows a user to save an entered signature for future signature tasks. A “Save signature” option 426, if provided, may be inactive until a signature is entered into the provided signature field 420. In practice, the “accept and complete” button 410 may be inactivated or otherwise not selectable until text is typed into the text entry box 420. In this manner, the task 402 related to completing the electronic document 406 may be completed upon entry of a typed signature and an affirmative indication of acceptance (i.e., selecting the “accept and complete” button 410).

Turning to FIG. 9, an alternative is illustrated in which a drawn signature is instead selected via drawn signature tab 422. In response to this selection, a drawn signature entry box 430 may be displayed which may receive an input from an electronic writing implement (e.g., a stylus), finger (in a touch screen context), or entry of a saved image file of a drawn signature. A “Save signature” option 426 and/or “Clear signature” option 432, if provided, may be inactive until a signature is entered into the provided signature field 430. As with the typed signature, the “accept and complete” button 410 may be inactivated or otherwise not selectable until an entry is made into drawn signature entry box 430. In this manner, the task 402 related to completing the electronic document 406 may be completed upon entry of a drawn signature and an affirmative indication of acceptance (i.e., selecting the “accept and complete” button 410).

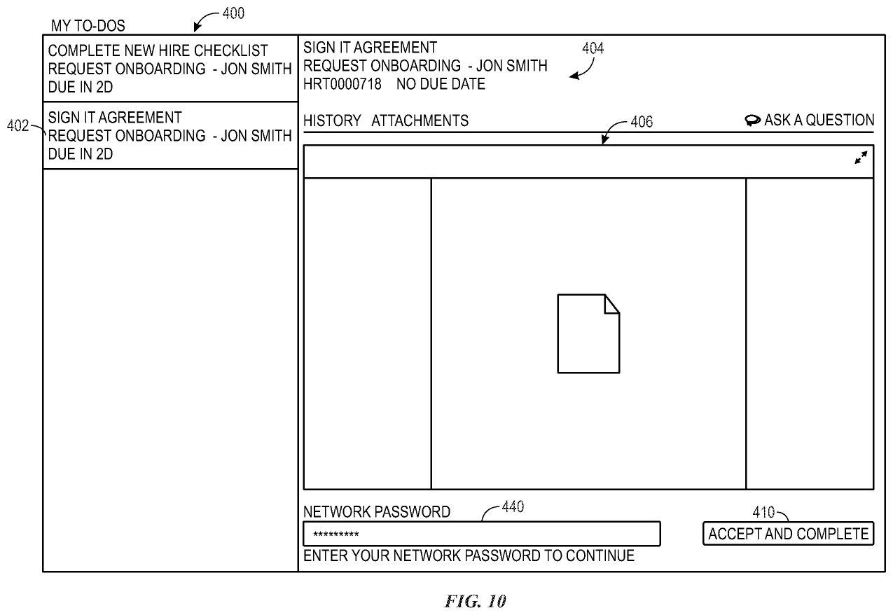

While the preceding two example involve capture of a signature (either written or typed) corresponding to the name of an individual, in other contexts a credential of the signer may instead be captured in addition to or instead of a name-based signature. An example of this is illustrated in FIG. 10 where a password entry box 440 is provided so that a user may enter a password or other authenticating credential (which may be masked when entered) as an identifier and to signify acceptance and signing of the document 406. As in the preceding examples, in practice the “accept and complete” button 410 may be inactivated or otherwise not selectable until text is typed into the password entry box 440. In this manner, the task 402 related to completing the electronic document 406 may be completed upon entry of a typed credential other than a name-based signature and an affirmative indication of acceptance (i.e., selecting the “accept and complete” button 410).

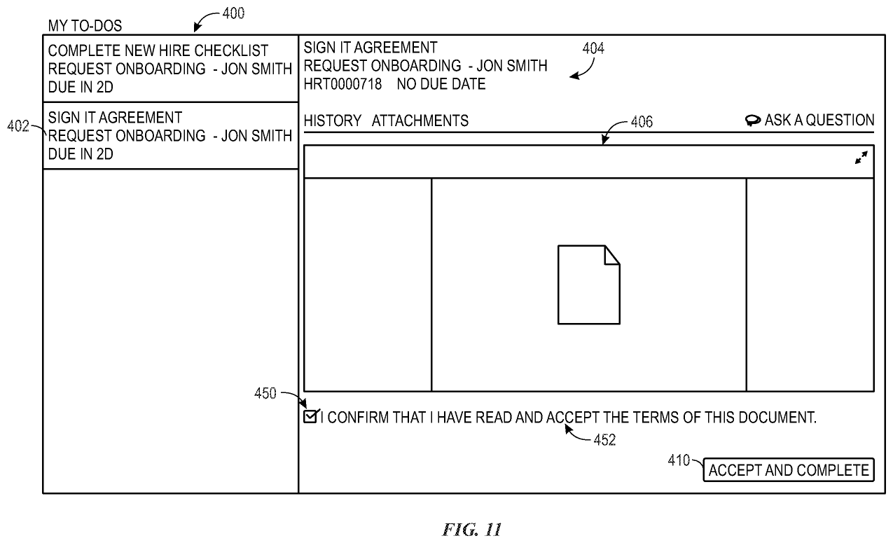

Turning to FIG. 11, an example is illustrated in which the task 402 related to acceptance of the document 406 instead involves obtaining an affirmative acknowledgement of the document 406 (e.g., an acknowledgement the document has been read or reviewed). In this example, a statement 452 as to the terms being acknowledged by the user is displayed. A selectable or Tillable field (e.g., checkbox 450) may be provided in conjunction with the statement 452 so as to allow a reviewer to indicate acknowledgment of the terms of the statement 452 by selection of or entry of data into the field (e.g., checkbox 450). Thus, a user of the application may review the document 406 and the statement 452 and indicate acknowledgment of and/or agreement with the terms in the statement 452 by selecting the checkbox 450. Upon indicating their acknowledgement, the user may select the “accept and complete” button 410. As in preceding examples, the “accept and complete” button 410 may be inactivated or otherwise not selectable until the user affirmatively indicates their acknowledgement. In this manner, the task 402 may be completed upon entry of an indication of acknowledgment of the terms present in statement 452 and an affirmative indication of acceptance (i.e., selecting the “accept and complete” button 410) of that acknowledgment.

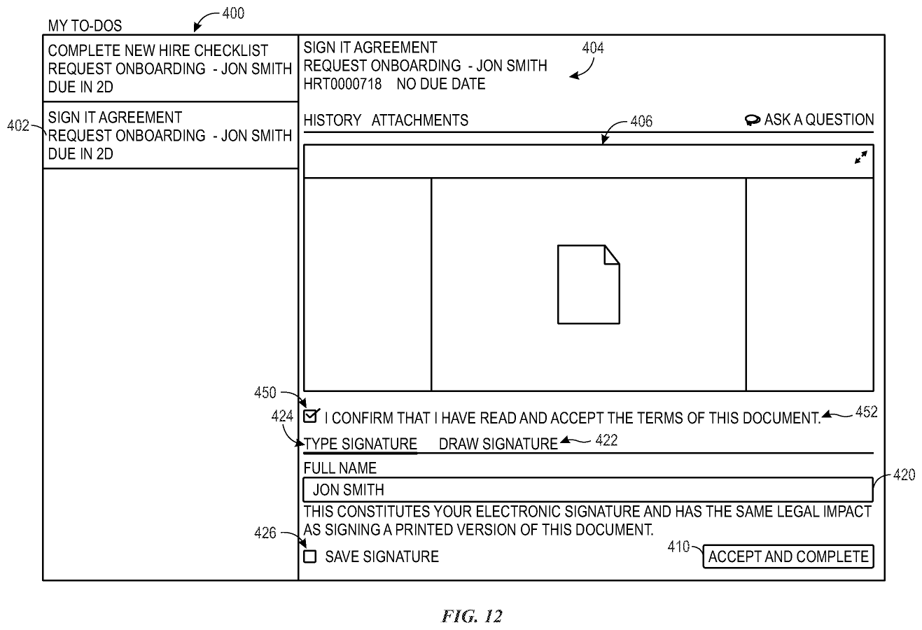

Turning to FIG. 12, an example of a combination of the signature and acknowledgement concepts is depicted as part of a task 402. In this example, the user may review the document 406 and the statement 452 and indicate acknowledgment of and/or agreement with the terms in the statement 452 by selecting the checkbox 450. In addition, the reviewer provides a signature in the form of a credential or name-based signature (here a typed signature is shown by way of example) in a provided field (here text entry box 420). In practice, the signature area (typed or drawn) may be inactive or unavailable until a reviewer provides an affirmative acknowledgement (such as via checkbox 450). As in preceding example, the “accept and complete” button 410 may be inactivated or otherwise not selectable until a signature is provided and the user affirmatively indicates their acknowledgement with respect to the statement 452. In this manner, the task 402 related to completing the electronic document 406 may be completed upon entry by the reviewer of an acknowledgment of the stated terms specified in statement 452, entry of a signature (or credential), and an affirmative indication of acceptance (i.e., selecting the “accept and complete” button 410) of the signature and acknowledgment. As noted above, upon completion of the signature and/or acknowledgement and affirmative acceptance, the task 402 may be indicated as completed and removed from the task list 400.

Turning to an example of the present approach in the context of a mobile device, FIGS. 13-24 illustrate certain of the aspects described above as they may be implemented as part of a mobile application. In this example, a mobile device screen (e.g., a cellular telephone or tablet computer screen) is depicted on which a task list 400 configured for the mobile device screen is displayed. As shown, the task list 400 may be displayed on a mobile device user interface of an individual associated with an organization (e.g., a company, government, facility, and so forth). The task list 400 may be displayed as part of a user portal or interface accessed by the mobile device when connected to a client instance in a cloud computing environment. Unlike in the desktop display implementation, additional information such as summary information 404 or the electronic document 406 are not displayed in conjunction with the task list 400 on the mobile device due to space limitations.

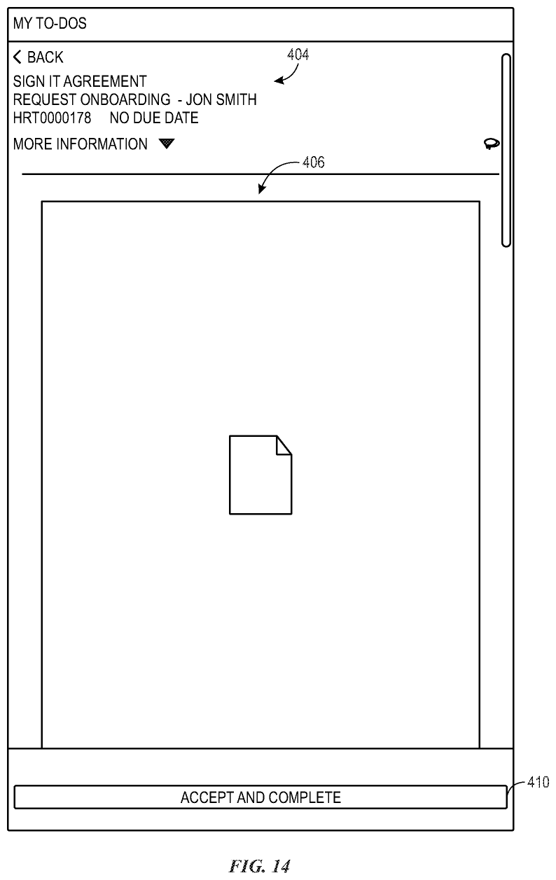

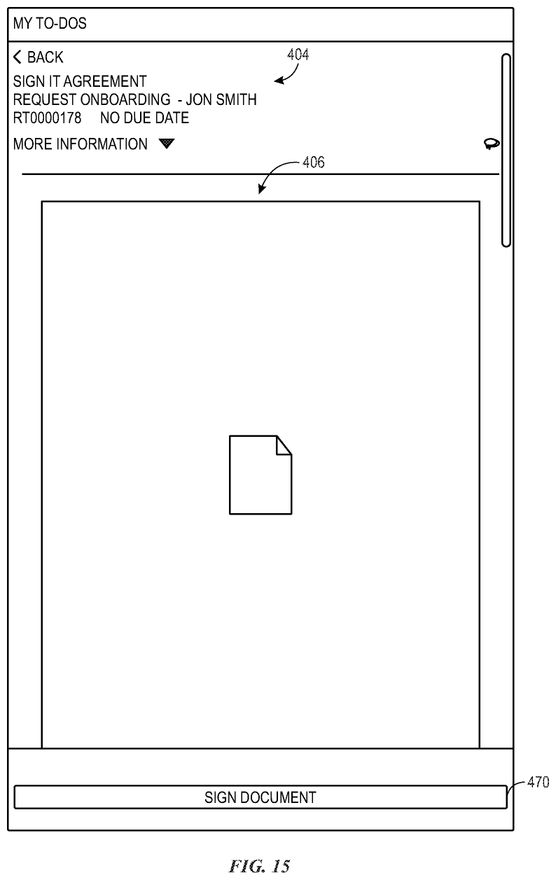

Instead, upon selection of a task on the task list 400, the interface may change or be updated to remove the task list 400 and display the summary information 404 and the electronic document 406, as shown in FIG. 14. As illustrated, FIG. 14 depicts a non-signature example as a base-line for discussion. In this baseline example, no specific signature or acknowledgement task has been defined for the task 402, so instead of a signature or acknowledgement, the task 402 may be completed simply by accepting (“accept and complete” button 410) the electronic document 406 without providing an affirmative acknowledgement, signature, or credential.

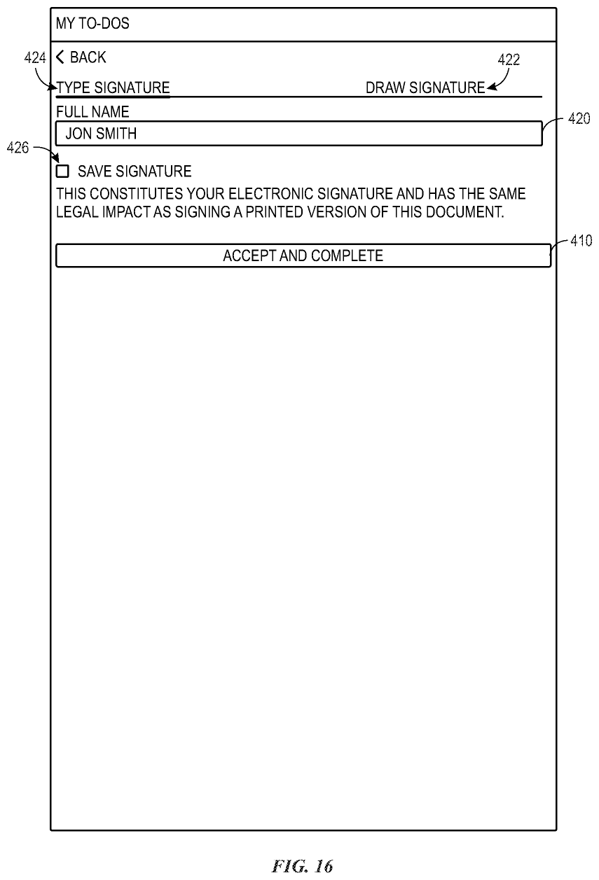

Turning to FIG. 15, in an example of a mobile implementation certain functions may be split between different screens so as to accommodate the form factor and size of a mobile device screen. With this in mind, FIG. 15 illustrates an implementation in which the task 402 (the information 404 of which is shown in conjunction with the electronic document 406) has been configured so as to require a signature. In the depicted example, requiring the signature to complete the task prompts the display of a “sign document” button 470 that, when selected, causes a signing screen to be displayed on the mobile device, as shown in FIG. 16.

As shown in FIG. 16, the signing screen on a mobile device displays a text entry box 420 as well as selectable tabs corresponding to a typed signature 424 or a drawn signature 422. In addition, a save signature box 426 is provided which, if selected, allows a user to save an entered signature for future signature tasks. A “Save signature” option 426, if provided, may be inactive until a signature is entered into the provided signature field 420. In practice, the “accept and complete” button 410 may be inactivated or otherwise not selectable until text is typed into the text entry box 420. In this manner, the task 402 related to completing the electronic document 406 may be completed upon entry of a typed signature on the mobile device and an affirmative indication of acceptance (i.e., selecting the “accept and complete” button 410).

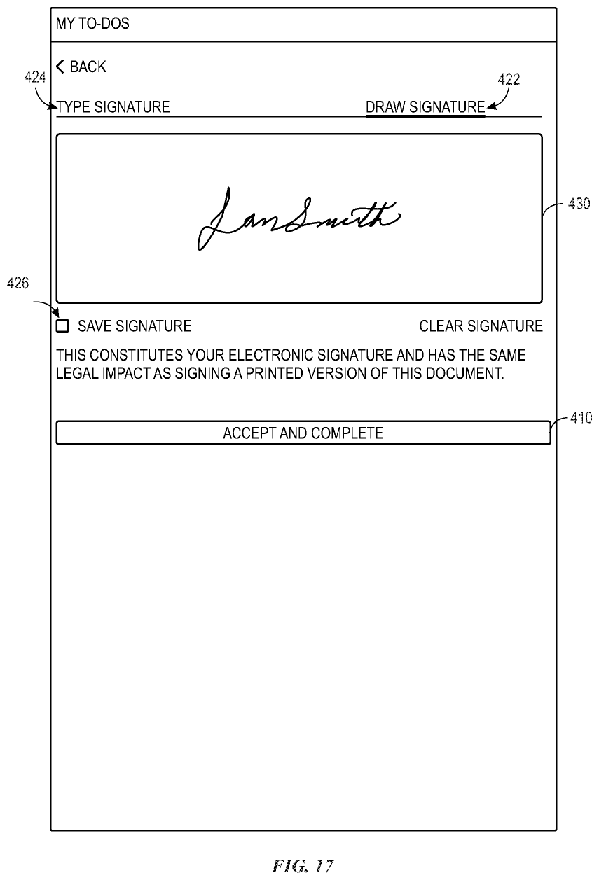

Turning to FIG. 17, in this example, an alternative is illustrated in which a drawn signature is instead selected via drawn signature tab 422 on the mobile device. In response to this selection, a drawn signature entry box 430 may be displayed which may receive an input from an electronic writing implement (e.g., a stylus), finger (in a touch screen context), or entry of a saved image file of a drawn signature. A “Save signature” option 426 and/or “Clear signature” option 432, if provided, may be inactive until a signature is entered into the provided signature field 430.As with the typed signature, the “accept and complete” button 410 may be inactivated or otherwise not selectable until an entry is made into drawn signature entry box 430. In this manner, the task 402 related to completing the electronic document 406 may be completed upon entry of a drawn signature and an affirmative indication of acceptance (i.e., selecting the “accept and complete” button 410).

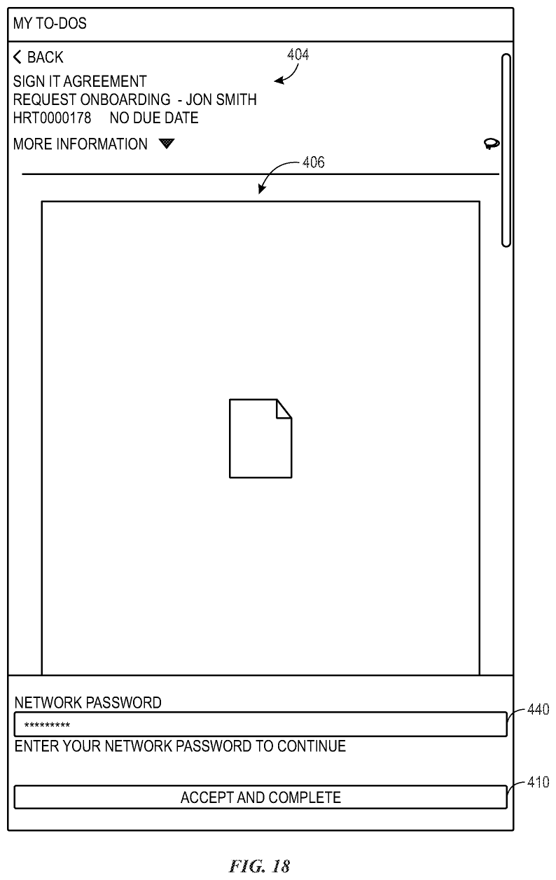

Turning to FIG. 18, a further alternative is illustrated on the mobile device in which, a credential of the signer may instead be captured in addition to or instead of a name-based signature. In this example, a password entry box 440 is provided so that a user may enter a password or other authenticating credential (which may be masked when entered) as an identifier and to signify acceptance and signing of the document 406. As in the preceding examples, in practice the “accept and complete” button 410 may be inactivated or otherwise not selectable until text is typed into the password entry box 440. In this manner, the task 402 related to completing the electronic document 406 may be completed upon entry of a typed credential other than a name-based signature and an affirmative indication of acceptance (i.e., selecting the “accept and complete” button 410).

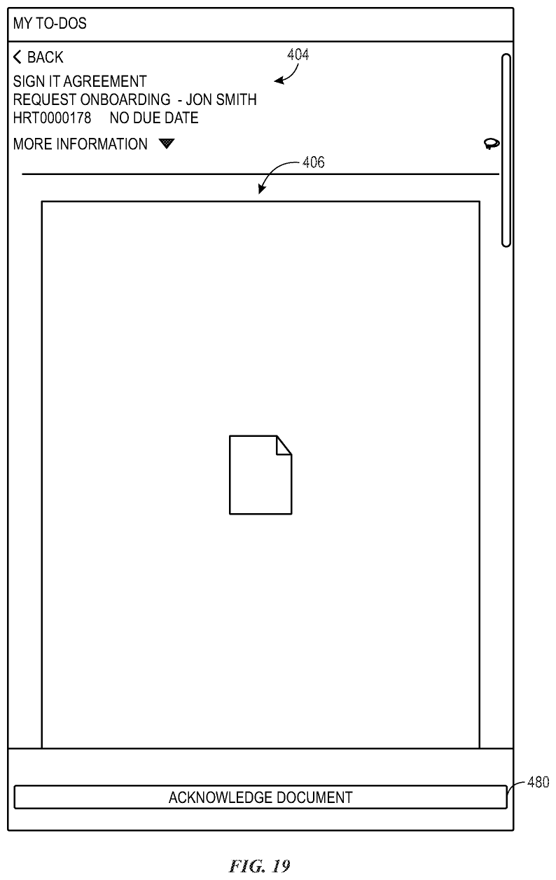

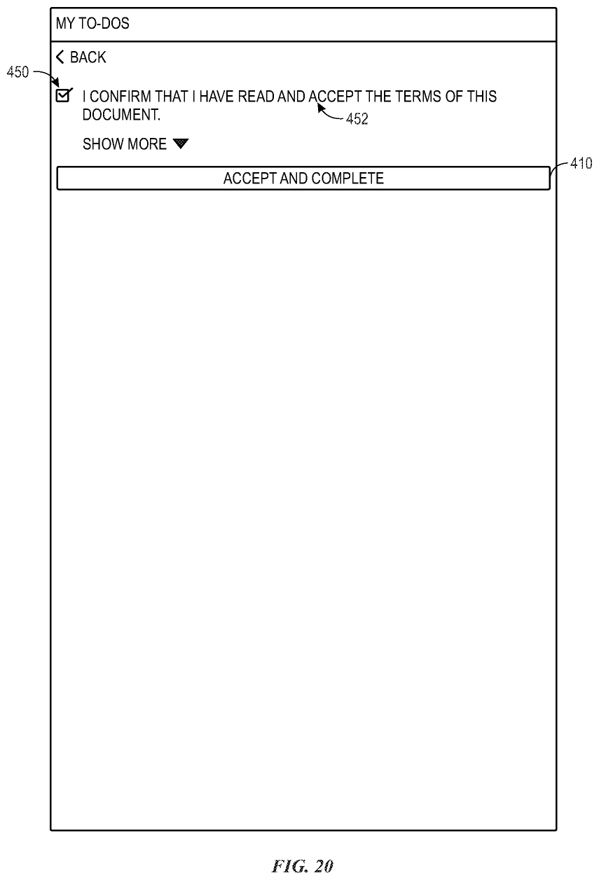

As in the desktop display examples described herein, the mobile application implementations may also be designed and/or configured to acquire acknowledgments (e.g., an acknowledgement the document has been read or reviewed) in addition to or instead of signatures (or credentials). With this in mind, FIG. 19 illustrates an implementation in which the task 402 (the information 404 of which is shown in conjunction with the electronic document 406) has been configured so as to require an acknowledgement. In the depicted example, requiring the acknowledgment to complete the task prompts the display of an “acknowledge document” button 480 that, when selected, causes an acknowledgement screen to be displayed on the mobile device, as shown in FIG. 20.

As shown in FIG. 20, the acknowledgement screen on the mobile device displays a statement 452 as to the terms being acknowledged by the reviewer. A selectable or fillable field (e.g., checkbox 450) may be provided in conjunction with the statement 452 so as to allow a reviewer to indicate acknowledgment of the terms of the statement 452 by selection of or entry of data into the field (e.g., checkbox 450). Thus, a user of the mobile application may review the document 406 and the statement 452 and indicate acknowledgment of and/or agreement with the terms in the statement 452 by selecting the checkbox 450 using an input method suitable for a mobile device. Upon indicating their acknowledgement, the user may select the “accept and complete” button 410. As in preceding examples, the “accept and complete” button 410 may be inactivated or otherwise not selectable until the user affirmatively indicates their acknowledgement. In this manner, the task 402 may be completed upon entry of an indication of acknowledgment of the terms present in statement 452 and an affirmative indication of acceptance (i.e., selecting the “accept and complete” button 410) of that acknowledgment.

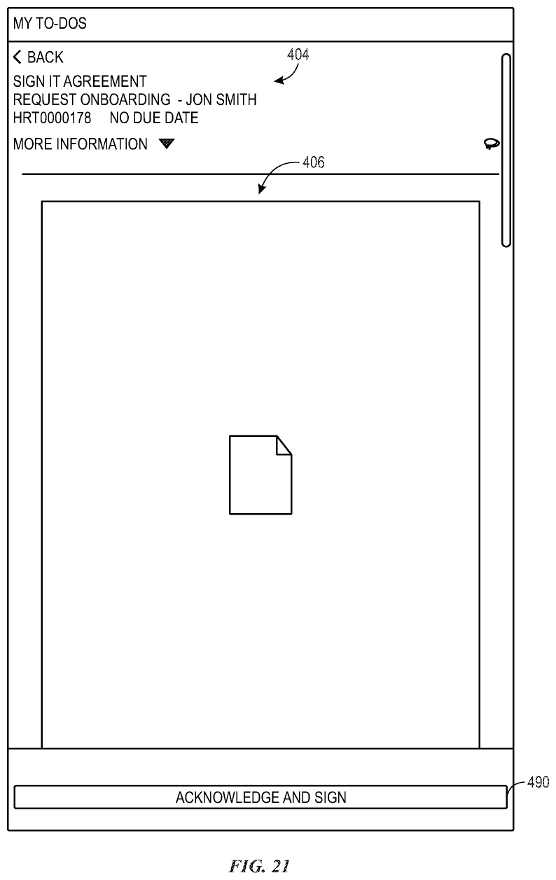

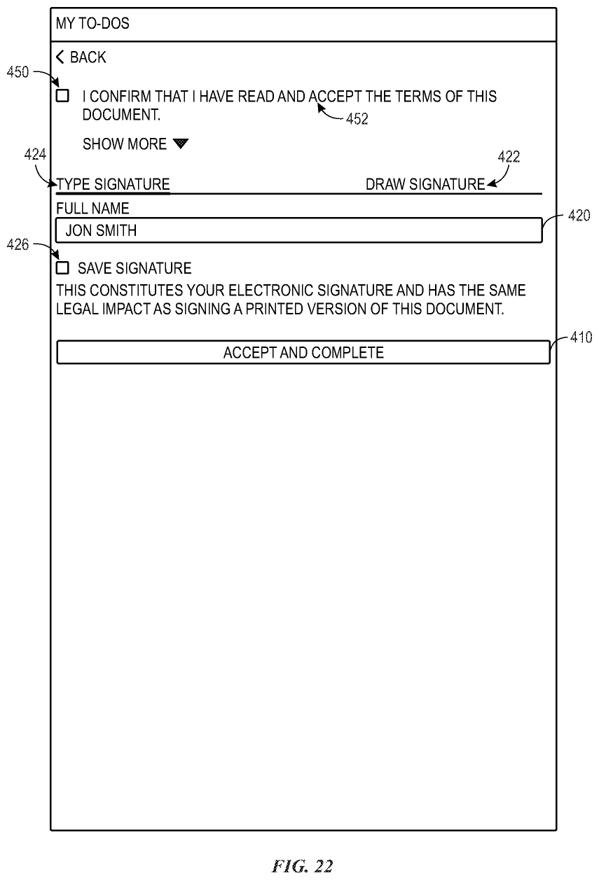

Turning to FIG. 21, an example of a combination of the signature and acknowledgement concepts as implemented on a mobile device is depicted. In this example, the user may review the document 406. Upon reviewing the document, the user may interact with (e.g., press) an “acknowledge and sign” button 490 that, when selected, causes an acknowledgement and signature screen to be displayed on the mobile device, as shown in FIG. 22.

As shown in FIG. 22, the acknowledgement and signature screen on the mobile device displays a statement 452 as to the terms being acknowledged by the reviewer. The reviewer may review the statement 452 and indicate acknowledgment of and/or agreement with the terms in the statement 452 by selecting the checkbox 450. In addition, the reviewer provides a signature in the form of a credential or name-based signature (here a typed signature is shown by way of example) in a provided field (here text entry box 420). In practice, the signature area (typed or drawn) may be inactive or unavailable until a reviewer provides an affirmative acknowledgement (such as via checkbox 450). As in preceding example, the “accept and complete” button 410 may be inactivated or otherwise not selectable until a signature is provided and the user affirmatively indicates their acknowledgement with respect to the statement 452. In this manner, the task 402 related to completing the electronic document 406 may be completed upon entry by the reviewer of an acknowledgment of the stated terms specified in statement 452, entry of a signature (or credential), and an affirmative indication of acceptance (i.e., selecting the “accept and complete” button 410) of the signature and acknowledgment. As noted above, upon completion of the signature and/or acknowledgement and affirmative acceptance, the task 402 may be indicated as completed and removed from the task list 400.

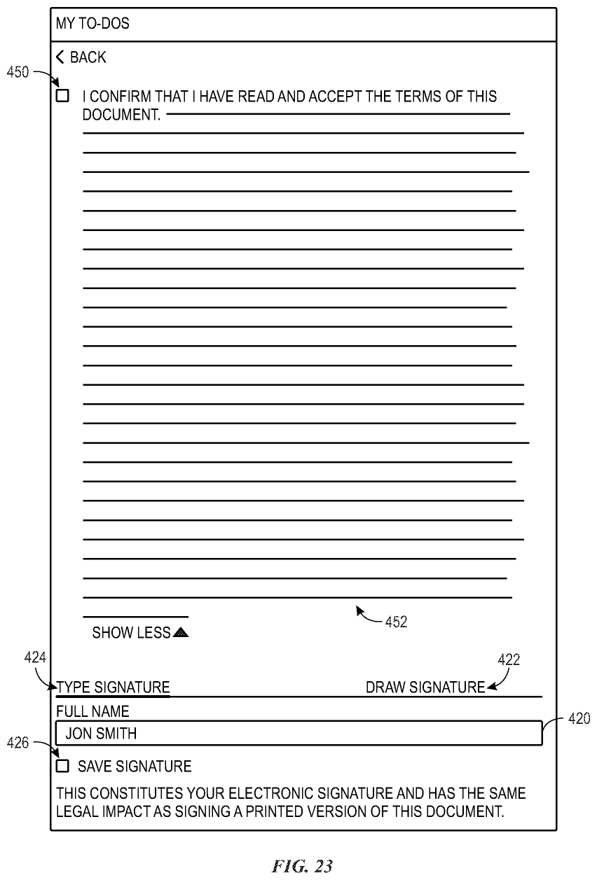

As noted above, implementation of signature and/or acknowledgment functionality on a mobile device may present certain issues with respect to display space and form factor constraints. With this in mind, FIG. 23 illustrates a further adaptation with respect to providing acknowledgment functionality on a mobile device. In this example, a user may interact with the displayed interface to cause the display of a full acknowledgment passage 452, as opposed to a truncated passage that may be displayed by default to avoid spilling over the screen boundary. This may be useful to allow a reviewer to read the entire acknowledgment passage before providing an acknowledgement. A scroll bar 484 may be provided, as needed, to allow a reviewer to proceed through a lengthy passage and/or to allow the reviewer to access functionality provided beneath the passage, such as signature and acknowledgement options.

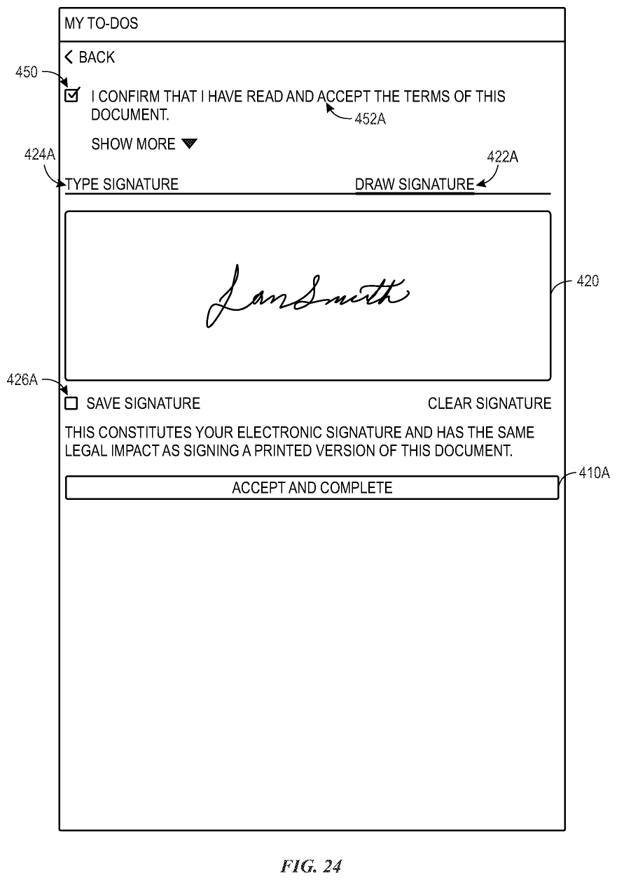

In addition, turning to FIG. 24, it should be appreciated that the various signature and acknowledgment functionality described herein may be adapted or translated, such as based on user provided language preferences, locale information known for the user (such as from employment or personnel records, geo-location based on IP address, GPS signal, or cell signal), and so forth. With this in mind, FIG. 24 depicts an example of an acknowledgment and signature screen adapted or translated to a different language (here, German) relative to other examples herein. In this example, translated passages are indicated with an “A” suffix to the corresponding reference number. Such locale or preference-based translation may be provided in conjunction with either desktop display or mobile applications.

Further, as noted herein the signature and/or acknowledgment functionality described herein, including design aspects and task list integration, may be provided as a plug-in, so as to allow incorporation (e.g., as a module, extension, or plug-in) into various different applications or routines, such as human resources applications, legal department applications, accounting and/or finance applications, customer service applications, event or incident management applications, and so forth. In this manner, a plug-in may be associated with different applications or routines to add a common functionality (e.g., electronic signature and/or acknowledgement functionality) in a modular fashion to the different applications or routines.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
one or more client instances hosted by a platform, wherein the one or more client instances support application and data access on one or more remote client networks, wherein the system is configured to perform operations comprising:
in response to a process step being reached, causing the display of a task on a task list on a user interface of a client device in communication with a respective client instance, wherein the task is for acquiring one or more of a signature, a credential, or an acknowledgement;
in response to a selection of the task from the task list, causing one or more interaction regions to be displayed on the user interface, wherein the one or more interaction regions are configured to receive one or more of an electronic signature input, a credential input, or an acknowledgment input;
in response to one or more of the electronic signature input, the credential input, or the acknowledgment input being provided in the respective interaction regions and an acceptance input being received, updating the task as completed and removing the task from the task list.

2. The system of claim 1, wherein the client device comprises a desktop device and the user interface comprises a desktop user interface.

3. The system of claim 2, wherein the client device comprises a mobile device and the user interface comprises a mobile device user interface.

4. The system of claim 1, wherein the electronic signature input comprises one of a typed signature or a drawn signature.

5. The system of claim 1, wherein the credential comprises a password.

6. The system of claim 1, wherein acknowledgement text is displayed on the user interface with a respective interaction region configured to receive the acknowledgement input.

7. The system of claim 1, wherein an electronic document or form is displayed on the user interface at the same time or before the one or more interaction regions are displayed.

8. A method for acquiring an electronic signature or acknowledgment, comprising:
generating a task for acquiring one or more of a signature, a credential, or an acknowledgement;
causing the display of the task on a task list displayed on a user interface;
in response to a selection of the task from the task list, causing the display of one or more interaction regions for receiving one or more of an electronic signature input, a credential input, or an acknowledgment input; and
in response to receiving one or more the electronic signature input, the credential input, or the acknowledgment input and an acceptance input, updating the task as completed and removing the task from the task list.

9. The method of claim 8, wherein the user interface is displayed on a client device in communication with a client instance hosted on a cloud computing platform.

10. The method of claim 9, wherein the user interface comprises a mobile device user interface.

11. The method of claim 10, wherein the mobile device user interface comprises a succession of navigable screens configured to fit the size and form factor of a mobile device.

12. The method of claim 8, wherein a respective interaction region of the one or more interaction regions is configured to receive either a typed or drawn electronic signature.

13. The method of claim 8, wherein a respective interaction region of the one or more interaction regions is configured to receive a password as a credential.

14. The method of claim 8, wherein a respective interaction region of the one or more interaction regions is configured to receive a user interaction as the acknowledgement input.

15. The method of claim 8, further comprising:
displaying acknowledgement text on the user interface with a respective interaction region configured to receive the acknowledgement input.

16. A signature or acknowledgement task generation interface, comprising:
a task table selection field configured to receive a first indication corresponding to a task table accessible on a network or cloud platform;
a signature-type selection field configured to receive a second indication corresponding to one or more types of signature to be acquired as part of a respective signature or acknowledgement task;
an acknowledgement field or selectable control configured to receive a third indication corresponding to whether an acknowledgment is to be acquired as part of the respective signature or acknowledgement task; and
a document type field configured to receive a fourth indication corresponding to one or more document types with which the respective signature or acknowledgment task is associated.

17. The signature or acknowledgement task generation interface of claim 16, wherein input to the signature-type selection field is optional so that the respective signature or acknowledgement task requires only an acknowledgement.

18. The signature or acknowledgement task generation interface of claim 16, wherein input to the acknowledgment field or selectable control is optional so that the respective signature or acknowledgement task requires only a signature.

19. The signature or acknowledgement task generation interface of claim 16, further comprising an acknowledgment text field configured to receive an acknowledgment statement to be displayed as part of the respective signature or acknowledgement task.

20. The signature or acknowledgement task generation interface of claim 16, further comprising a document name field configured to receive a fifth indication corresponding to a respective document name with which the respective signature or acknowledgment task is associated.
